(19) United States
(12) Patent Application Publication
(10) Pub. No.: US 2007/0002829 A1
(43) Pub. Date: Jan. 4, 2007

(54) Internet protocol voice logger

(76) Inventors: Su-Yuan Chang, Hsinchu (TW); Yin-Ju Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/154,713

(22) Filed: Jun. 17, 2005

(51) Int. Cl. H04M 3/00

(52) U.S. Cl. 370/352; 379/265.01

(57) ABSTRACT

The present invention provides a communication system, which comprising a plurality of user agents, a media relay gateway, a command center, and a session controller. Each user agent is capable of exchanging media stream with another user agent. The media relay gateway is used for receiving and forwarding media stream among said plurality of user agents. Moreover, the command center is used for receiving forwarded media stream from the media relay gateway. And the session controller re-directs and associate exchanged media streams between the plurality of user agents to said media relay gateway according to a monitor command of said command center.

### BACKGROUND OF THE INVENTION

1. Field of the Invention

The present invention generally relates to Internet Protocol voice communication, and more particularly to Internet Protocol voice logger.

2. Description of the Prior Art

Packet switch voice communication is getting more and more popular in this Internet age. However, due to many reasons, such as regulations, law enforcement, and national security, legal interception of voice communication is required for wide area voice communication.

Conventionally, it is required to have a top application layer processing mechanism to filter, monitor, and/or record voice stream through the backbone or trunk communication wires. Normally the legal interception requires heavy burden on the central packet switches and/or routers since all packets have to be parsed and compared with a list of filter, monitor, and/or record conditions. When one more condition is added into the list, there would be one more comparison on every packet. As the list grows, the limited computing power would be exhausted once.

Moreover, except for communication setup stage, packet voice communication over IP (Internet Protocol) is based on end-to-end communication. In practical, it is very difficult to intercept all possible routing paths between one end and another end. Hence, there exists a need of a IP voice logger system and method for wide area network.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention provides a communication system, which comprising a plurality of user agents, a media relay gateway, a command center, and a session controller. Each user agent is capable of exchanging media stream with another user agent. The media relay gateway is used for receiving and forwarding media stream among said plurality of user agents. Moreover, the command center is used for receiving forwarded media stream from the media relay gateway. And the session controller re-directs and associate exchanged media streams between the plurality of user agents to said media relay gateway according to a monitor command of said command center.

The session controller re-directs exchanged media streams between said plurality of user agents by the following steps: at first receiving a call invitation, by said session controller, from a caller of said plurality of user agents; sending a first set relay message, by said session controller, to said media relay gateway; receiving a first relay message identification, by said session controller, from said media relay gateway with a first media IP (Internet Protocol) address and a first port number of said media relay gateway; sending a first invitation to a callee of said plurality of user agents, by said session controller, with said first media IP address and said first port number of said media relay gateway; receiving a first okay message from said callee; sending a second set relay message, by said session controller, to said media relay gateway; receiving a second relay message identification, by said session controller, from said media relay gateway with a second media IP (Internet Protocol) address and a second port number of said media relay gateway; sending a invitation response to said caller, by said session controller, with said second media IP address and said second port number of said media relay gateway; and sending an associate relay message, by said session controller, to said media relay gateway with said first and said second relay message identifications.

The present invention provides a communication log method, which comprises providing a communication system, which comprising a plurality of user agents, a media relay gateway, a command center, and a session controller. Each user agent is capable of exchanging media stream with another user agent. The media relay gateway is used for receiving and forwarding media stream among said plurality of user agents. Moreover, the command center is used for receiving forwarded media stream from the media relay gateway. And the session controller re-directs and associate exchanged media streams between the plurality of user agents to said media relay gateway according to a monitor command of said command center.

Moreover, the communication log method comprising the following steps: at first receiving a call invitation, by said session controller, from a caller of said plurality of user agents; sending a first set relay message, by said session controller, to said media relay gateway; receiving a first relay message identification, by said session controller, from said media relay gateway with a first media IP (Internet Protocol) address and a first port number of said media relay gateway; sending a first invitation to a callee of said plurality of user agents, by said session controller, with said first media IP address and said first port number of said media relay gateway; receiving a first okay message from said callee; sending a second set relay message, by said session controller, to said media relay gateway; receiving a second relay message identification, by said session controller, from said media relay gateway with a second media IP (Internet Protocol) address and a second port number of said media relay gateway; sending a invitation response to said caller, by said session controller, with said second media IP address and said second port number of said media relay gateway; and sending an associate relay message, by said session controller, to said media relay gateway with said first and said second relay message identifications.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates an IP voice logger system of an embodiment in accordance with the present invention;

FIG. 2 is a sequence diagram depicts a standard call flow between both user agents shown in the FIG. 1;

FIG. 3 is a sequence diagram shows a static voice log call flow between the both user agents shown in the FIG. 1;

FIG. 4 is a sequence diagram shows a static monitor and un-monitor call flow 400 of an embodiment in accordance with the present invention; and

FIG. 5 is a sequence diagram shows a dynamic monitor call flow of another embodiment in accordance with the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

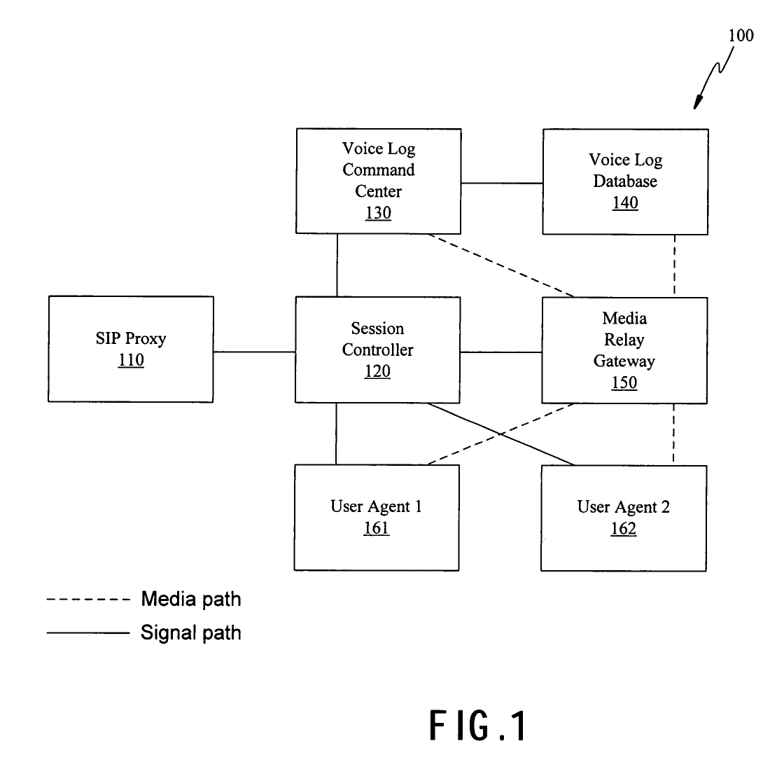

Please refer to FIG. 1, which shows an IP voice logger system 100 of an embodiment in accordance with the present invention. This IP voice logger system 100 comprises a SIP (Session Initiation Protocol) proxy 110, a session controller 120, a voice log command center 130, a voice log database 140, a media relay gateway 150, and a plurality of user agents 160. In this embodiment, two user agents, UA1 161 and UA2 162, of the plurality of user agents are intended to communicate to each other in some kinds of RTP (Real-Time Protocol). The session controller 120 and the media relay gateway 150 are packet reachable by the both user agents, UA1 161 and UA2 162. Please note that the number of the SIP proxy 110, the session controller 120, and the media relay gateway 150 of the IP voice logger system 100 is not restricted. In other words, there could be more than one SIP proxy 110, session controller 120, and media relay gateway 150 in the system 100.

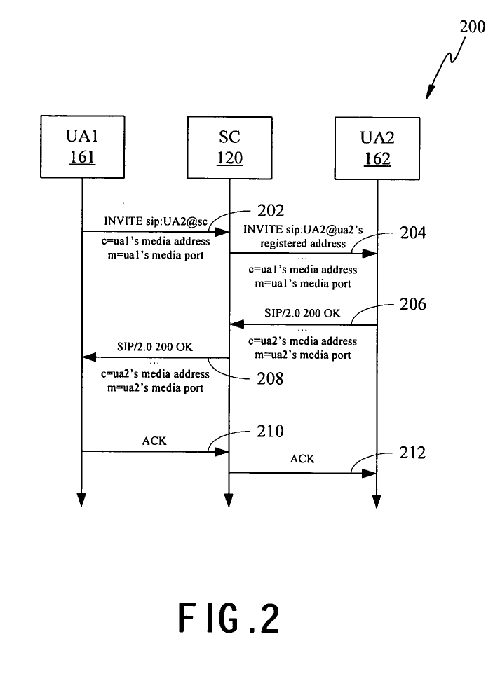

Now please refer to FIG. 2, which shows a standard call flow 200 between both user agents shown in the FIG. 1. In case the UA1 161 wants to set up a call to the UA2 162, the UA1 161 sends an invitation to the session controller 120 with a SIP address of the UA2 162, the media address, and port of the UA1 161 in a step 202. After receiving the invitation, the session controller 120 forwards this invitation to the registered address of the UA2 162 in a consequent step 204. In step 206, the UA2 162 returns an okay message to the session controller 120 with its own media address and port. Once receiving the okay message of the UA2 162, the session controller 120 relays it to the UA1 161 in a following step 208. Once more, the session controller 120 forwards the acknowledgement message from the UA1 161 to the UA2 162 in step 210 and 212. After the call setup flow 200, the media streams exchanged between the UA1 161 and the UA2 162 are not passed through the session controller 120. Hence, it is impossible to monitor and record the exchanged media streams.

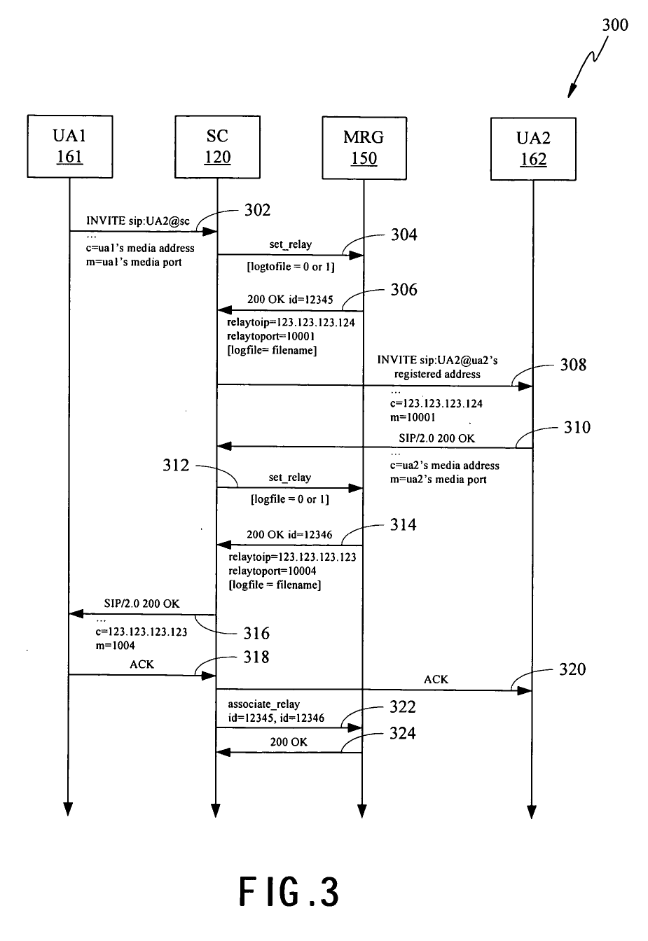

Now please refer to FIG. 3, which shows a static voice log call flow 300 between the both user agents shown in the FIG. 1. When administrator needs to monitor any call issued by the UA1 161, the voice log command center 130 would issue a command to the session controller 120 for adding UA1 161 in an attention list. In a step 302 similar to the step 202, the UA1 161 sends an invitation to the session controller 120 with a SIP address of the UA2 162, the media address, and port of the UA1 161. After receiving this invitation, the session controller 120 loops up the caller, UA1 161, in the attention list. In case the UA1 161 is found in the attention list, the session controller 120 issues a set relay message to the media relay gateway 150 in a step 304. Within this set relay message, an optional parameter, logtofile, could be denoted to command the message relay gateway 150 to log the relayed media stream. Once receiving the set relay message, the media relay gateway 150 returns an okay message to the session controller 120 with a first relay message identification, a first IP address “ relay_to_ip”, and a first port “relay_to_port” in a step 306. In response of the optional parameter of the set relay message, the media relay gateway 150 may return a file name of the logged media stream. In this regards, instead of forwarding the media address and port of the UA1 161 to the registered address of the UA2 162, the session controller 120 sends an invitation to the UA2 162 with the first relay_to_ip and the first relay_to_port media parameters in a step 308.

Similar to the step 206, the UA2 162 returns an okay message to the session controller 120 with its own media address and port in a step 310. Once receiving the okay message of the UA2 162, the session controller 120 issues a second set relay message with an optional parameter “logtofile” to the media relay gateway 150 again in a step 312.

Also similar to the step 306, the media relay gateway 150 returns an okay message to the session controller 120 with a second relay message identification, a second IP address “relay_to_ip”, and a second port “relay_to_port” in a step 314. Next, processing a step 316, the session controller 120 returns an okay message to the UA1 161 with the second relay_to_ip, and the second relay_to_port as media parameters. Finally, the session controller 120 forwards the acknowledgement message from the UA1 161 to the UA2 162 in step 318 and 320. At last, since the session controller 120 collected two relay message identifications in step 306 and 314, the session controller 120 issues an associate relay command to the media relay gateway 150 with these two relay message identifications in step 322. After receiving these two relay message identifications, the media relay gateway 150 could associate the media streams together by returning an okay message in step 324.

After executing static voice log call flow 300, the media stream between the UA1 161 and the UA2 162 would be sent to and processed by the media relay gateway 150. Therefore the media relay gateway 150 could forward the processed media stream to the voice log command center 130 and/or the voice log database 140 for real-time monitor or storage.

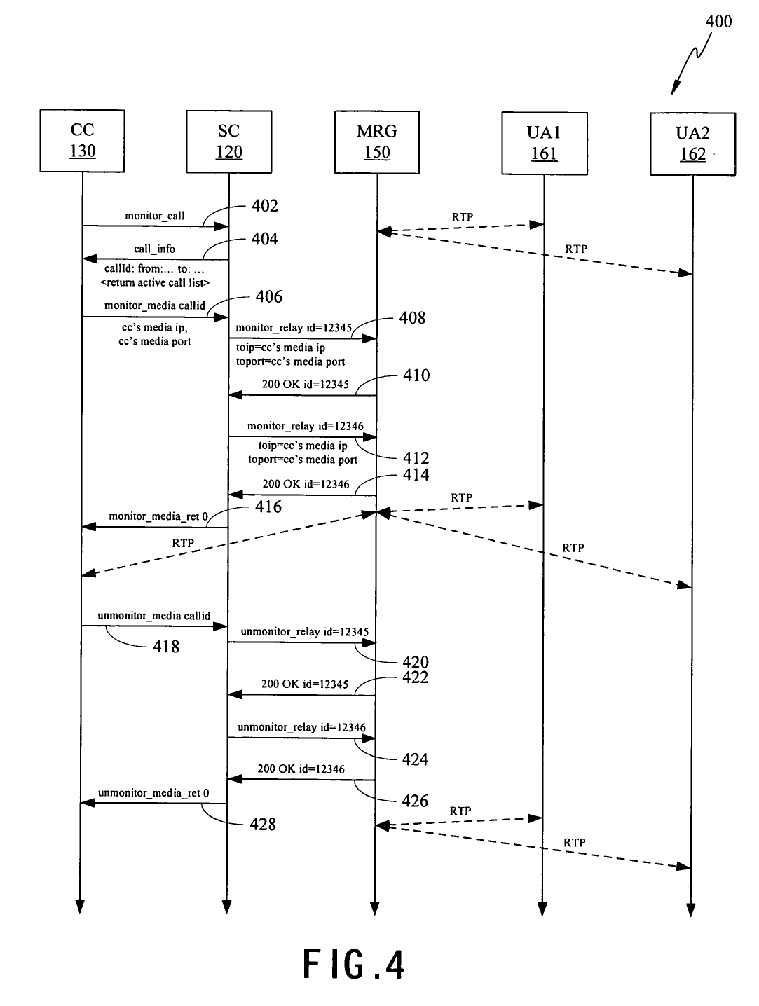

Please refer to FIG. 4, which shows a static monitor and un-monitor call flow 400 of an embodiment in accordance with the present invention. When the media stream between the UA1 161 and the UA2 162 is already processed by the media relay gateway 150, the command center 130 could issue a monitor_call command to the session controller 120 to retrieve a call list in a step 402. Next, in a step 404, the session controller 120 returns a call_info message to the command center 130 with a call list in response of the monitor_call command. The call list is composed by call records, which at least denotes a call identification, a caller identification, and a callee identification. In this regards, the command center 130 issues a monitor_media command to the session controller 120 with a chosen call identification, and the media IP address and port of the command center 130 in a step 406.

Once receiving the monitor_media command, the session controller 120 issues two monitor_relay commands to the media relay gateway 150 in order to duplicate relayed media stream to the command center 130 in step 408 and 412. In step 408, a first monitor_relay command brings the first relay message identification, which is issued by the media relay gateway 150 beforehand, and the media IP and port of the command center 130 to the media relay gateway 150. Hence, in a step 410, an okay message with the first relay message identification is returned to the session controller 120. Similarly, in step 412, a second monitor_relay command brings the second relay message identification, which is issued by the media relay gateway 150 beforehand, and the media IP and port of the command center 130 to the media relay gateway 150. Hence, in a step 414, an okay message with the first relay message identification is returned to the session controller 120. Please notify that the present invention does not restrict the order of these two monitor_relay commands. At last, the session controller 120 gives the command center a successful return value of previous monitor_media command in a step 416. After that, all relayed media stream between the UA1 161 and the UA2 162 would be duplicated and sent to the command center 130 by the media relay gateway 150. Therefore, the command center 130 could decode, replay, record, forward, and/or do any possible processing of the forwarded media stream.

As shown in the FIG. 4, in case the command center 130 wants to cease monitoring, the command center 130 issues a un-monitor_media command to the session controller 120 with the call identification in a step 418. The call identification is used in the monitor_media command of the previous step 406. Once receiving the un-monitor_media command, the session controller 120 issues two un-monitor_relay commands to the media relay gateway 150 in order to cease duplicating relayed media stream to the command center 130 in step 408 and 412. In a step 420, a first un-monitor_relay command brings the first relay message identification, which is issued by the media relay gateway 150 beforehand, to the media relay gateway 150. Hence, in a step 422, an okay message with the first relay message identification is returned to the session controller 120. Similarly, in a step 424, a second un-monitor_relay command brings the second relay message identification, which is issued by the media relay gateway 150 beforehand, to the media relay gateway 150. Hence, in a step 426, an okay message with the second relay message identification is returned to the session controller 120. At last, the session controller 120 gives the command center a successful return value of previous un-monitor_media command in a step 428. After that, all relayed media stream between the UA1 161 and the UA2 162 would not be duplicated and sent to the command center 130 by the media relay gateway 150.

In an example of the embodiment shown in the FIG. 4, the command center 130 could issue the monitor_media command with the media IP and port of the voice log database 140 in the step 406. Therefore the relayed media stream would be forwarded to the voice log database 140 by the media relay gateway 150 for recording and/or post processing. In another example of the embodiment, the command center 130 could re-forward the received media stream to the voice log database 140 and/or any machines.

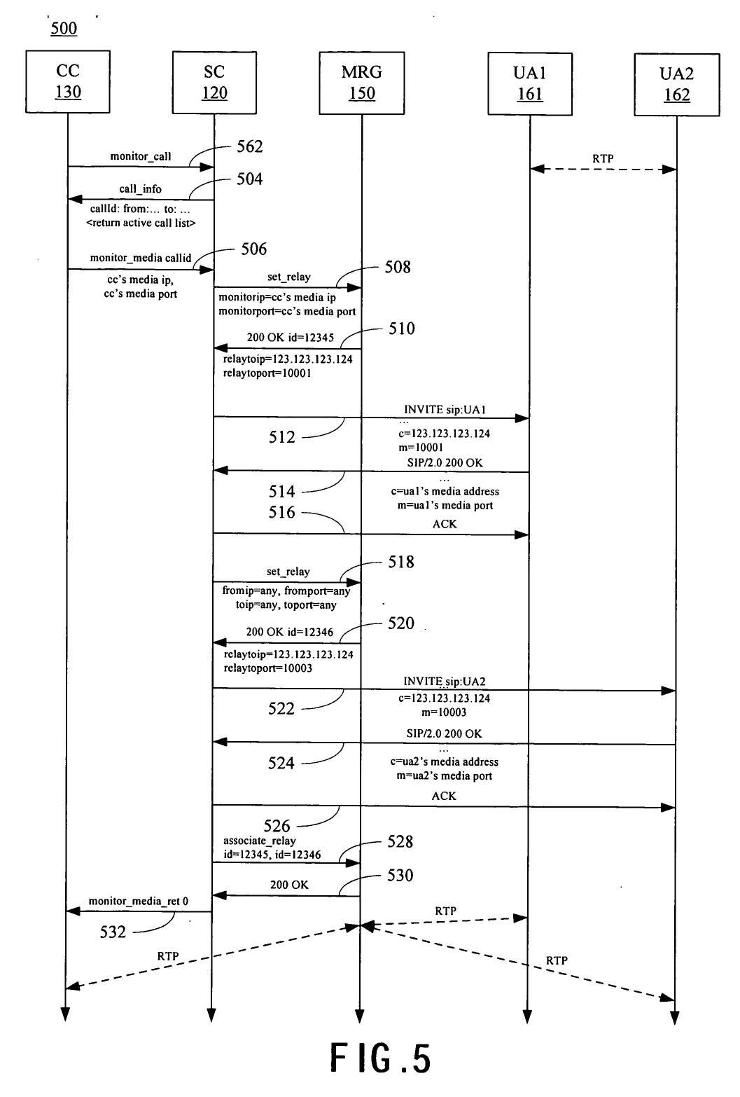

In the embodiment shown in the FIG. 4, the command center 130 could monitor the relayed media stream merely. However, the command center 130 could dynamically monitor media stream in another embodiment shown in the FIG. 5.

Please refer to the FIG. 5, which shows a dynamic monitor call flow 500 of another embodiment in accordance with the present invention. As the same as the embodiment shown in the FIG. 4, the command center 130 could issue a monitor_call command to the session controller 120 to retrieve a relayed call list in a step 502. Next, in a step 504, the session controller 120 returns a call_info message to the command center 130 with the call list in response of the monitor_call command. In this regards, the command center 130 issues a monitor_media command to the session controller 120 with a chosen call identification, and the media IP and port of the command center 130 in a step 506.

Since the media stream between the UA1 161 and the UA2 162 does not pass through the media relay gateway 150, the session controller 120 has to redirect the media stream at first. Similar with the step 304 and 306, the session controller 120 issues a set relay message to the media relay gateway 150 in a step 508. Once receiving the set relay message, the media relay gateway 150 returns an okay message to the session controller 120 with a first relay message identification, a first relay_to_ip, and a first relay_to_port in a step 510. In this regards, the session controller 120 sends an invitation to the UA1 161 with the first relay_to_ip and the first relay_to_port media parameters in a step 512. In response of the invitation, the UA1 161 returns an okay message to the session controller 120 in a step 514. Furthermore, the session controller 120 returns an acknowledgement of the okay message back to the UA1 161 in a step 516.

After negotiating with the UA1 161 from step 508 to 516, the session controller 120 deals with the UA2 162 from step 518 to 526 in the same way. The session controller 120 issues a set relay message to the media relay gateway 150 in a step 518. Once receiving the set relay message, the media relay gateway 150 returns an okay message to the session controller 120 with a seoncd relay message identification, a seoncd relay_from_ip, a seoncd relay_from_port, a seoncd relay_to_ip, and a seoncd relay_to_port in a step 520. In this regards, the session controller 120 sends an invitation to the UA2 162 with the seoncd relay_to_ip and the seoncd relay_to_port media parameters in a step 522. In response of the invitation, the UA2 162 returns an okay message to the session controller 120 in a step 524. Furthermore, the session controller 120 returns an acknowledgement of the okay message back to the UA2 162 in a step 526.

Similar to the step 322 and 324 shown in the FIG. 3, the session controller 120 issues an associate relay command to the media relay gateway 150 with these two relay message identifications in step 528. After receiving these two relay message identifications, the media relay gateway 150 could associate the media streams together by returning an okay message in step 530. Finally, the session controller 120 returns an okay message to the command center 130 in step 532.

The present invention does not only apply on the SIP application, but also on any other suitable packet switch communication protocol. The mentioned media stream may comprise voice, video, and/or any other types of data. In the present invention, the communication between any components in this system 100 may be encrypted, compressed, and/or certificated. For example, the command center 130 may be certificated in prior to sending commands to the session controller 120.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A communication system, comprising:
a plurality of user agents, wherein each user agent is capable of exchanging media stream with another user agent;
a media relay gateway for receiving and forwarding media stream among said plurality of user agents;
a command center for receiving forwarded media stream from said media relay gateway; and
a session controller, wherein said session controller re-directs and associate exchanged media streams between said plurality of user agents to said media relay gateway according to a monitor command of said command center.

2. A communication system of claim 1, wherein said plurality of user agents and said session controller are followed SIP (Session Initiation Protocol).

3. A communication system of claim 2, further comprising:
at least one SIP proxy for intermediating media stream among said plurality of user agents.

4. A communication system of claim 1, further comprising:
a log database for keeping tracks of logged information.

5. A communication system of claim 1, wherein said media stream comprising voice, video, and any other formats of data.

6. A communication system of claim 1, wherein said media relay gateway records received media stream into file.

7. A communication system of claim 2, wherein said session controller re-directs exchanged media streams between said plurality of user agents by the following steps:
receiving a call invitation, by said session controller, from a caller of said plurality of user agents;
sending a first set relay message, by said session controller, to said media relay gateway;
receiving a first relay message identification, by said session controller, from said media relay gateway with a first media IP (Internet Protocol) address and a first port number of said media relay gateway;
sending a first invitation to a callee of said plurality of user agents, by said session controller, with said first media IP address and said first port number of said media relay gateway;
receiving a first okay message from said callee;
sending a second set relay message, by said session controller, to said media relay gateway;
receiving a second relay message identification, by said session controller, from said media relay gateway with a second media IP (Internet Protocol) address and a second port number of said media relay gateway;
sending a invitation response to said caller, by said session controller, with said second media IP address and said second port number of said media relay gateway; and
sending an associate relay message, by said session controller, to said media relay gateway with said first and said second relay message identifications.

8. A communication system of claim 7, wherein said monitor command comprising a media IP address and a port number of said command center.

9. A communication system of claim 8, further comprising:
sending a first monitor relay command, by said session controller, with said first relay message identification, said media IP address, and said port number of said command center to said media relay gateway; and
sending a second monitor relay command, by said session controller, with said second relay message identification, said media IP address, and said port number of said command center to said media relay gateway.

10. A communication system of claim 9, wherein said media relay gateway sends received media stream from said caller and said callee to said media IP address and said port number of said command center.

11. A communication log method, comprising:
providing a communication system, wherein said communication system comprising:
a plurality of user agents, wherein each user agent is capable of exchanging media stream with another user agent;
a media relay gateway for receiving and forwarding media stream among said plurality of user agents;
a command center for receiving forwarded media stream from said media relay gateway; and
a session controller, wherein said session controller re-directs and associate exchanged media streams between said plurality of user agents to said media relay gateway according to a monitor command of said command center;
receiving a call invitation, by said session controller, from a caller of said plurality of user agents;
sending a first set relay message, by said session controller, to said media relay gateway;
receiving a first relay message identification, by said session controller, from said media relay gateway with a first media IP (Internet Protocol) address and a first port number of said media relay gateway;
sending a first invitation to a callee of said plurality of user agents, by said session controller, with said first media IP address and said first port number of said media relay gateway;
receiving a first okay message from said callee;
sending a second set relay message, by said session controller, to said media relay gateway;
receiving a second relay message identification, by said session controller, from said media relay gateway with a second media IP (Internet Protocol) address and a second port number of said media relay gateway;
sending a invitation response to said caller, by said session controller, with said second media IP address and said second port number of said media relay gateway; and
sending an associate relay message, by said session controller, to said media relay gateway with said first and said second relay message identifications.

12. A communication log method of claim 11, wherein said plurality of user agents and said session controller are followed SIP (Session Initiation Protocol).

13. A communication log method of claim 12, further comprising:
at least one SIP proxy for intermediating media stream among said plurality of user agents.

14. A communication log method of claim 11, wherein said communication system further comprising:
a log database for keeping tracks of logged information.

15. A communication log method of claim 11, wherein said media stream comprising voice, video, and any other formats of data.

16. A communication log method of claim 11, wherein said media relay gateway records received media stream into file.

17. A communication log method of claim 11, wherein said monitor command comprising a media IP address and a port number of said command center.

18. A communication log method of claim 17, further comprising:
sending a first monitor relay command, by said session controller, with said first relay message identification, said media IP address, and said port number of said command center to said media relay gateway; and
sending a second monitor relay command, by said session controller, with said second relay message identification, said media IP address, and said port number of said command center to said media relay gateway.

19. A communication log method of claim 18, wherein said media relay gateway sends received media stream from said caller and said callee to said media IP address and said port number of said command center.
